(19) United States
(12) Patent Application Publication
(10) Pub. No.: US 2005/0002566 A1
(43) Pub. Date: Jan. 6, 2005

(54) Method and apparatus for discriminating between different regions of an image

(76) Inventors: Riccardo Di Federico, Monza (IT); Leonardo Camiciotti, Firenze (IT)

Correspondence Address: Philips Electronics North America Corporation;Corporate Patent Counsel, PO Box 3001, Briarcliff Manor, NY, 10510, US

(21) Appl. No.: 10/492,004

(22) PCT Filed: Oct. 10, 2002
(86) PCT No.: PCT/IB02/04181

(30) Foreign Application Priority Data
Oct. 11, 2001 (EP) 01203860.0

(51) Int. Cl. G06K 9/34

(52) U.S. Cl. 382/176

(57) ABSTRACT

The invention provides for a method of, and related apparatus for discriminating between synthetic and natural regions of an image composed of a matrix of rows and columns of pixels. The method comprises the steps of: dividing a matrix of luminance values of the pixels of the image into blocks, the blocks representing a block map identifying whether the blocks are of a natural image type or a synthetic image type by analysis of a gradient matrix (G) of luminance gradients of the luminance values in the block and clustering blocks of a same image type into respective natural and synthetic regions of the image. The step of identifying whether the blocks are of the natural image type or the synthetic image type comprises the step of calculating the gradient matrix (G) within each block on the basis of a first order difference value of the luminance values L of the pixels in a row and a column direction of the block.

The present invention relates to a method, and related apparatus, for discriminating between synthetic and natural regions of an image composed of a matrix of rows and columns of pixels, the method comprising the steps of: dividing a matrix of luminance values of the pixels of the image into blocks, the blocks representing a block map, identifying whether the blocks are of a natural image type or a synthetic image type by analysis of a gradient matrix G of luminance gradients of the luminance values in the block and clustering blocks of a same image type into respective natural and synthetic regions of the image. The invention further relates to a display device comprising a display screen and an image enhancer.

Many aspects of signal processing applications, such as feature extraction and content driven processing, compression and retrieval operations, are heavily dependent upon the ability to accurately segment the display into regions that are considered likely to display a natural image, such as a photo or video image, and regions likely to display so-called synthetic images such as computer generated text and/or graphics regions.

By discriminating between the data representing regions of the display that are either classified as natural or synthetic, natural or synthetic content-dedicated algorithms can then be employed so as to provide for further, and particularly appropriate and accurate, signal processing applications. Without such segmentation, the universal application of an algorithm to the complete display occurs and disadvantages can arise. For example, the same image-enhancement algorithms applied to both natural and synthetic regions of an image will serve to produce significant improvements in the perceived quality of the natural image regions but will lead disadvantageously to artifacts in the synthetic parts of the display.

Thus, it can prove inappropriate to attempt to enhance the complete display without first seeking to discriminate, and separate, the natural regions of the display from synthetic regions of the display. Once such different regions have been identified, respectively appropriate processing algorithms can then be applied.

Of course, further advantages can arise in handling the image data in this manner. For example, the automatic optimization of the bandwidth utilization in coding applications such as arranging a fax machine to adopt separate encoding schemes for video images and for pure text/graphics content can be achieved.

U.S. Pat. No. 6,195,459 discloses an algorithm arranged for discriminating between natural and synthetic regions of an image and which provides for a block-analysis of the display with subsequent clustering of blocks found likely to fall either in the synthetic or natural category. The, generally rectangular, area formed by such clustered blocks is then refined and either accepted as a synthetic or natural region responsive to further analysis steps, or discarded.

However, such a known arrangement is disadvantageously limited in the range of graphics patterns that can be accurately identified and also with regard to its general accuracy and efficiency and its sensitivity to noise.

Also, this known algorithm is arranged to operate in accordance with a method that is considered unnecessarily complex and which exhibits a relatively high computational load which can disadvantageously restrict the accurate operation of the algorithm in some circumstances.

The present invention seeks to provide for a method and apparatus of the above-mentioned type which offers advantages over known such methods and apparatus. The invention is defined by the independent claims. The dependent claims define advantageous embodiments.

According to one aspect of the present invention, there is provided a method of the above-mentioned type characterized in that the step of identifying whether the blocks are of the natural image type or the synthetic image type comprises the step of calculating the gradient matrix within each block on the basis of a first order difference value of the luminance values L of the pixels in a row and a column direction of the block

The invention is advantageous in that classification can be based solely upon estimation of the luminance gradient. Also employing an absolute first order difference value proves advantageous since the adoption of simple first order differences assists in accurately identifying blocks displaying non-natural images for a greater potential variety of graphical patterns.

The feature of claim 2 is advantageous in simplifying the classification of each block as either a synthetic or a natural block.

The features of claims 3 to 6 prove particularly advantageous in limiting the effect that additive noise might otherwise have on the classification procedure.

The feature of claim 7 offers an effective and simple arrangement for cleaning the block while also clustering those blocks that are determined as likely to be of a common type.

The features of claims 8 to 13 are advantageous in limiting the computational load since, for example, the identification or generation of different connected component regions is unnecessary.

Also, the acceptance or rejection of the regions as either synthetic or natural can be based on border regularity and so not only upon the percentage of natural blocks within a rectangle.

The feature of claim 14 is advantageous in introducing a final refinement step allowing for edge detection of, for example, the rectangle at pixel level.

In general, the computational load of each step in the method of the present invention is lower than comparable steps of the prior art.

According to another aspect of the present invention, there is provided an apparatus for discriminating between natural and synthetic regions of a displayed image, including discriminating means for dividing the image data into groups representing different respective blocks of pixels of the display, luminance gradient estimation means arranged for identifying whether the blocks are of a natural image type or synthetic image type, clustering means for further grouping the data so as to cluster blocks of the same type and analyzing means for analyzing a region formed by clustered blocks so as to confirm the said region as either representing a natural or synthetic image, characterized in that the luminance gradient estimation means is arranged to estimate the gradient by means of a first order difference value in the horizontal and vertical directions of the block.

The invention also provides for apparatus as defined above and arranged to operate in accordance with any one or more of the method steps defined above.

These and other aspects of the invention will be apparent from and elucidated with reference to the accompanying drawings, in which:

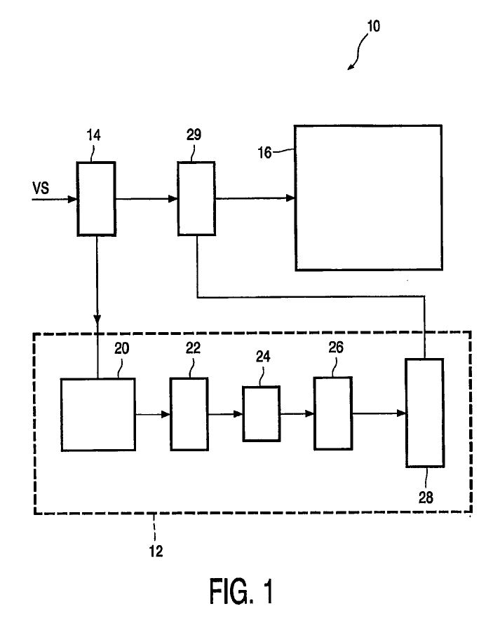

FIG. 1 is a schematic block diagram illustrating a monitor embodying the present invention;

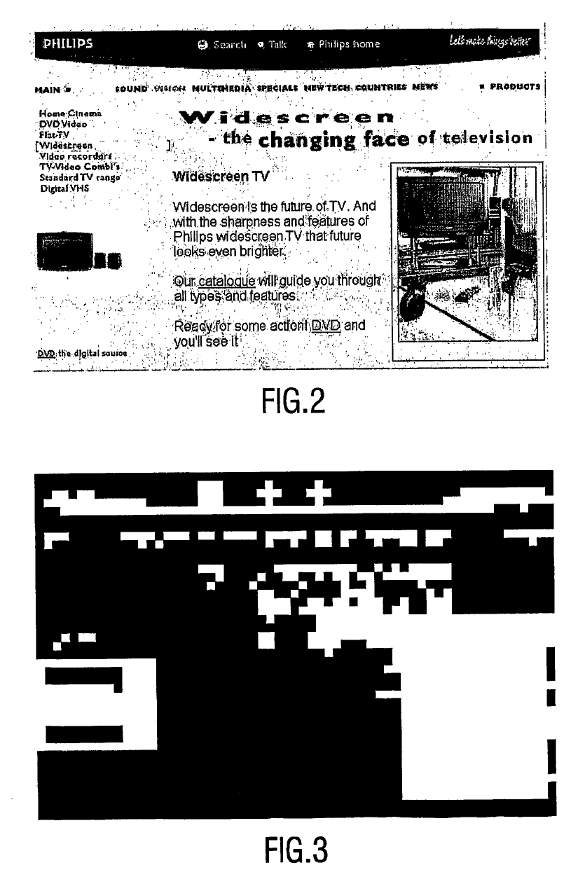

FIG. 2 is a representation of a composite natural/synthetic image as to be displayed on the display screen of the monitor of FIG. 1;

FIG. 3 is a block map of the original image of FIG. 1 illustrating those blocks of the display that are classified as either natural or synthetic blocks;

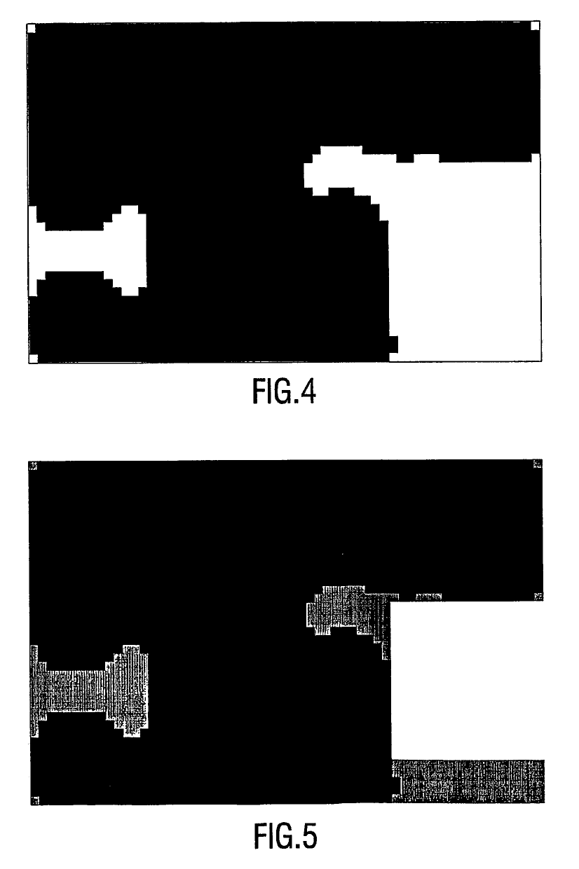

FIG. 4 is an illustration of the block map of FIG. 3 once having been subject to a clustering operation;

FIG. 5 is an illustration of the block map of FIG. 4 during the initial stages of a region verification step;

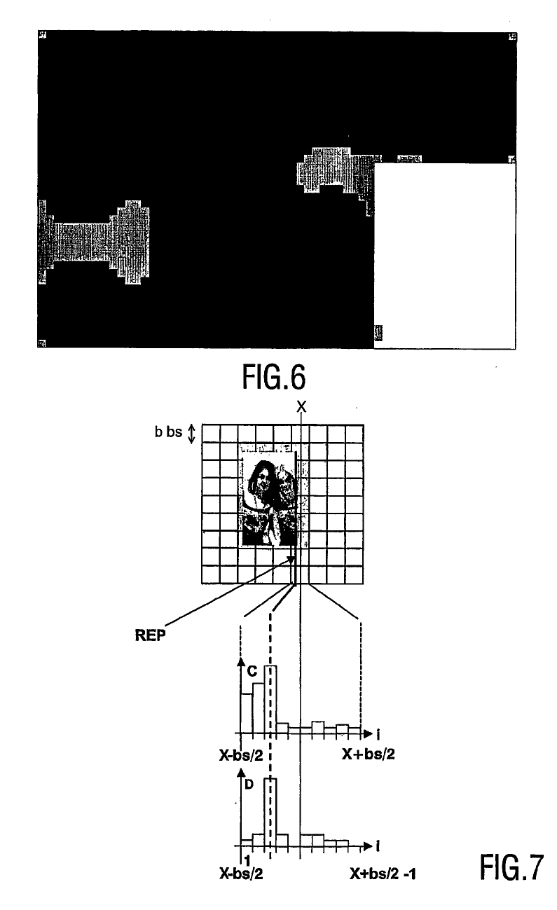

FIG. 6 is an illustration of the block map once the verification step illustrated with reference to FIG. 4 has been completed;

FIG. 7 illustrates a further refining step seeking to identify accurately the exact edge of a natural image; and

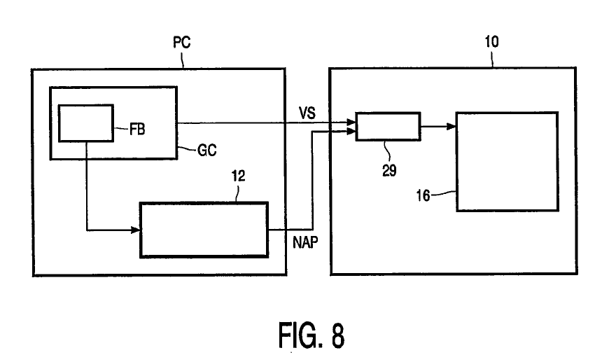

FIG. 8 illustrates another embodiment of the invention.

Turning first to FIG. 1, there is illustrated as a simplified schematic block diagram of a monitor 10 embodying the present invention. The monitor 10 includes a synthetic/natural image content detector 12 which is illustrated in functional block form. However, the detector 12 generally would be provided in the form of a control algorithm. The monitor further includes a display screen 16 and an image enhancer 29. The frame buffer 14 receives a video signal VS, which contains luminance data in a digital format. These data represent the luminance values L of an input image composed of a matrix of rows and columns of pixel elements.

In case of a moving image, the video signal VS contains a sequence of images, each image being represented by a matrix of luminance values L. In case the video signal VS contains information about the color components of each pixel, for example the values of the red, green and blue color components, then the luminance value can be derived from the values of the color components in a known manner. In order to simplify the explanations, the embodiment will be elucidated assuming that the video signal contains the luminance values L and that these values L are stored in the frame buffer 14.

The synthetic/natural image content detector 12 is connected to the frame buffer 14. The functional algorithm provided by the synthetic/natural image content detector 12 advantageously comprises an image classification algorithm and is arranged to offer recognition of natural regions of the image received in the form of the video signal VS. The image or images can be, for example, digitized photographs or video clips.

The luminance data are retrieved from the frame buffer 14 and divided in a block selection unit 20 in accordance with the algorithm into small square blocks. The content of the blocks is classified as either natural or synthetic in a luminance gradient estimation unit 22. The output of the gradient estimation unit is supplied to, a morphological filter 24 which clusters adjacent blocks into generally rectangular likely synthetic or natural regions. The clustered blocks are then further processed in a seed region grower 26, which grows a seed region in a step wise manner both in row direction and in column direction in an attempt to maximize the size of, for example, the likely rectangular natural image region.

Once having arrived at the likely maximum rectangular natural image region, the edge position refiner 28 accurately identifies, at a pixel level, the boundary of the natural image region.

Once one or more of such natural image regions have been identified in the image, this information can be used to determine which portions of the luminance data of that image should be subjected to which image processing and/or enhancement algorithms. So the image enchancer 29 receives the luminance data from the frame buffer 14 and information about the location of natural and synthetic regions. Based on these inputs the enhancer 29 executes the appropriate processing for each type of region. The output signal of the image enhancer 29 is used to drive the display screen.

In functional terms, the content detector searches for locations of the image for which there is a high probability that it is within a natural area. This is followed by a region growing procedure, which extends the initially estimated natural areas until a stop condition is verified.

The control algorithm as executed by the image detector 12 will be further elaborated below.

The input image is effectively first divided into small square blocks whose content is classified as either natural or synthetic based on a statistical procedure. The lower and upper bounds of the block side length are defined by the constraints imposed by the reliability of the evaluation measurement. For example, if the block is too small, too few pixels are considered and the measurement will not be representative of local characteristics. Alternatively, if the block size is too long, the block is likely to include misleading information. It has been found that a preferred value for the block side length is 10 pixels.

The natural/synthetic classification of each block is based on the following steps:
First, for all pixels within the image to be analyzed, the gradient matrix G of the luminance values L is determined using the formula:

$$G = max ( \vert \frac{\partial L}{\partial x} \vert , \vert \frac{\partial L}{\partial y} \vert ) ,$$

wherein

$$\frac{\partial L}{\partial x}$$

is the gradient in the row direction and

$$\frac{\partial L}{\partial y}$$

the gradient in the column direction. So, for each pixel the gradient matrix G contains a gradient value which is the largest of the gradient of that pixel in row or column direction. Then, if all the gradient values of pixels within a block are zero the block is marked as synthetic, since a perfectly constant luminance is not likely to be part of a natural image.
If all the gradient values within a block are below a predefined minimum threshold thₘᵢₙ, for example a value of 4, but greater than zero, the block is marked as natural. In this case the block is likely to be part of a uniform natural background such as a small part of the sky in a picture.
If the previous conditions are false, the average value \overline{G} over a subset of the gradient values within a block is computed. A high value of \overline{G} indicates a rapidly changing luminance, which is typical of a synthetic part of the image, since natural parts usually exhibit a small value. Therefore, in order to identify quantitatively such situations, a maximum threshold, thₘₐₓ, for example a value of 40, is defined for the average value with \overline{G},
\overline{G}<thₘₐₓ [symbol] block is natural,
\overline{G}>thₘₐₓ [symbol] block is synthetic.

The choice of the subset over which the average value \overline{G} is computed is best based on practical considerations. A common ‘synthetic’ situation such as text over slightly non-uniform background is that the luminance gradients of a few pixels are greatly different from most of the others. In this case an average value \overline{G} over the whole block would produce a small value, thus suggesting a wrong natural classification of the block. For this reason all elements of the gradient values G within the block whose value is below the minimum threshold thₘᵢₙ are excluded from the computation of the average value \overline{G}.

When all blocks of the image are classified, a morphological filtering is performed on the thus obtained natural/synthetic block map. This kind of processing helps in getting rid of spurious isolated blocks, by reclassifying them. This results in an improved clustering of blocks as shown in FIG. 4. In particular a “close” operation followed by an “open” operation is performed using, in both cases, the structuring element:

$$[ \begin{matrix}0 & 1 & 1 & 0 \\ 1 & 1 & 1 & 1 \\ 1 & 1 & 1 & 1 \\ 0 & 1 & 1 & 0\end{matrix} ]$$

A reference for morphological filtering is W. K. Pratt, Digital Image Processing, chapter 15, second edition, Wiley-Interscience, 1991.

Once all blocks have been classified as either natural or synthetic, and properly clustered by a morphological filter, the intention is then to identify ‘natural objects’, which generally comprise connected sets of natural blocks. There can be constraints on the shape of the natural objects to be targeted and in the present example, only rectangular regions are considered. Therefore, the algorithm must be able to determine the minimum sized rectangle, which comprises the object. It is important to note that the hypothesis of a rectangular shape is commonly met in many practical situations, such as photo archives on the Internet.

The following describes how to identify such rectangular areas, and the steps described can be iterated to find more than one natural object.

First, in the synthetic/natural block map the biggest square containing only natural blocks is sought. This is done by starting with the largest possible square, reducing step by step the dimensions of a starting square until the square just fits within the largest natural region of the block map as illustrated in FIG. 5. The length of a side of the starting square is the smallest value of the height and width of the block map. For each step the map is scanned line-wise by the square “seed region”, checking at each position whether or not a totally natural region can be “enclosed”. The step by step reduction is stopped at a lower limit of the square dimensions. This lower limit is determined by similar considerations as previously mentioned for the block size. A preferred choice for this lower limit was found to be 10×10 blocks. Therefore the shrinking process is stopped either when the “seed region” is correctly positioned on a totally natural region, or when the dimensions of the seed are less than the predetermined lower limit. In the latter case the algorithm exits, returning a negative result.

Assuming the “seed region” becomes correctly positioned, it is then grown, by adding rows of blocks in the column direction and/or columns of blocks in the row direction, following an iterative procedure. At each step the extension is done in such a way, that the grown seed region remains rectangular. At each step of the iteration the side to be grown is chosen according to the amount of new natural blocks that its expansion would include. In particular, at each step an extension with a new adjacent column or row of blocks is tested at each side. The side, among the four, with the highest percentage of new natural blocks in the column or row direction is chosen, provided that the percentage is over a predetermined threshold and the total amount of synthetic blocks within the “seed region” stays below 10%. A preferred value for the predetermined threshold is 30%. The growing process stops when none of the four sides of the seed region can be further extended as is the situation illustrated in FIG. 6.

Once the growing process stops, a further check on the shape of the natural region within the seed region can be performed, in order to ensure that the natural region is rectangular. Indeed even if the “grown seed” shape is rectangular, it could be placed inside a non-rectangular natural region. It should be noted that a perfectly rectangular natural region should normally not have any natural block adjacent to the grown seed region. Therefore it is determined whether for each side the percentage of externally adjacent natural blocks is below 40% and the mean percentage of the externally adjacent blocks for all sides together is below 20%.

Due to the step wise block growth of the procedure, the previous step is able to locate the edges with an error whose range is ½ block size. It has been noted that a natural image usually contains many gray levels, while the number of different gray levels within a synthetic image is low, so that the border between natural and synthetic areas is characterized by a dramatic variation in the number of gray levels. Therefore, the exact position of the edge is determined by finding the highest variation of the number of gray levels.

As an example and with reference to FIG. 7 for the right border located at column X, for each column within the error range, the number of different gray levels along the corresponding pixel column, C(i) (iε[X−bs/2, X+bs/2]), is computed. In the formula bs is the blocksize. In order to find the maximum variation of the number of different gray levels, the difference vector D(i)=|C(i+1)−C(i)|, (Iε[X−bs/2, X+bs/2−1]) is computed and searched for its maximum.

Then the exact position of the edge can be determined by maximizing D(i) as illustrated by the bounding of the natural image in FIG. 7. The real edge position with pixel level accuracy is indicated by arrow REP. Like wise the left border in column direction as well as the borders in row direction are determined. The gray colored blocks around the picture in the image shown in FIG. 7, indicate the seed region as result of the growing process.

Another embodiment of the invention is shown in FIG. 8. A computer PC includes a graphics card GC. The graphics card GC has a frame buffer FB, wherein the video signal VS is stored. The image content detector 12 is implemented in the form of software, adapted to run as a background process of an operating system of the computer PC. The content detector 12 analyses images, stored in the form of the video signal VS in the frame buffer FB. The natural content detector 12 computes the positions NAP of the natural area, in a way as described in the previous embodiment. The monitor 10 includes the image enhancer 29 and the display screen 16. The positions NAP resulting from the computation are supplied to the image enhancer 29. This enhancer also receives the video signal VS from the graphics card GC. So, with the information about the positions NAP of the natural areas, the image enhancer 29 is capable of enchancing the video signal VS in dependence on whether an area of an image contains natural or synthetic information.

It should be appreciated therefore that the present invention can offer advantages when compared with prior-art monitors.

As will be appreciated, classification of each block need only be based on the luminance gradient.

Also as compared with the Sobel operator used in U.S. Pat. No. 6,196,459, the gradient is estimated in a different and simpler way through the use of the maximum of the absolute first order difference value in horizontal and vertical directions. Moreover, the adoption of a simple first order difference helps in correctly labeling as non-natural a wider amount of graphics patterns. Indeed the proposed gradient estimator will give a non-zero output also for on-off sequences in graphics patterns, such as chessboard patterns or the horizontal cross section of an small sized ‘m’.

Further, it will be noted that the gradient average can be calculated over a subset of pixels not including those whose associated gradient is below a threshold thₘᵢₙ, rather than zero as in U.S. Pat. No. 6,196,459. This makes the estimation much less sensitive to additive noise. A block with very few text/graphic pixels over a very low contrast, but not mono-color, background, which may be generated also by a small amount of additive noise, will be correctly labeled therefore as a non-natural block.

As a general remark, the computational load of each step, and therefore the overall computational load of the algorithm is lower than known arrangements such as that disclosed in U.S. Pat. No. 6,196,459.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method for discriminating between synthetic and natural regions of an image composed of a matrix of rows and columns of pixels, the method comprising the steps of: dividing a matrix of luminance values of the pixels of the image into blocks, the blocks representing a block map; identifying whether the blocks are of a natural image type or a synthetic image type by analysis of a gradient matrix G of luminance gradients of the luminance values in the block; and clustering blocks of a same image type into respective natural and synthetic regions of the image, characterized in that the step of identifying whether the blocks are of the natural image type or the synthetic image type comprises the step of calculating the gradient matrix (G) within each block on the basis of a first order difference value of the luminance values L of the pixels in a row and a column direction of the block.

2. A method as claimed in claim 1, wherein the gradient matrix G is calculated according to
$$G = max ( \vert \frac{\partial L}{\partial x} \vert , \vert \frac{\partial L}{\partial y} \vert ) ,$$
wherein L represents the matrix of the luminance values of the pixels in the analyzed block, and wherein
$$\frac{\partial L}{\partial x} and \frac{\partial L}{\partial y}$$
respectively represent the luminance gradient in the row and the column direction.

3. A method as claimed in claim 1, including the step of determining if values in the gradient matrix G are between a predetermined threshold and zero.

4. A method as claimed in claim 3, wherein if a value in the gradient matrix G is above the predetermined threshold, the method includes a step of determining a subset of the gradient values in the gradient matrix G and determining whether an average gradient value of the subset is above a maximum threshold value.

5. A method as claimed in claim 4, wherein if the average gradient value is below the maximum threshold value, then the block is identified as part of a natural image, and if the average gradient value is above the maximum threshold, the block is identified as part of a synthetic image.

6. A method as claimed in claim 4, wherein gradient values below the predetermined threshold are excluded from the subset.

7. A method as claimed in claim 1, wherein a morphological filtering step is included employing a closed operation followed by an open operation so as to cluster blocks of a same type.

8. A method as claimed in claim 1, wherein a seed region comprising a plurality of blocks is reduced in dimension in a step wise manner until it is determined that the seed region is contained fully within a natural region of the block map.

9. A method as claimed in claim 8, wherein a further step of comparing a size of the step-wise decreasing seed region with a predetermined threshold dimension and ceasing the step-wise decrease either when the seed region is positioned totally within a natural region of the block map or once the size of the seed region is below the predetermined threshold dimension, is included.

10. A method as claimed in claim 8, wherein the step is included of increasing a size of the seed region in the row and/or the column direction in an attempt to maximize the size of the seed region determined to be within a natural region of the image.

11. A method as claimed in claim 10, wherein columns and/or rows of blocks are added to the seed region on the basis of a determination of which of the columns/rows exhibits a highest percentage of natural blocks.

12. A method as claimed in claim 10, wherein the increasing of the seed region ceases if a percentage of synthetic blocks within the seed region increases above a predetermined threshold percentage.

13. A method as claimed in claim 11, wherein the adding is stopped when a percentage of externally adjacent natural blocks in a row or in a column of blocks to be added is below a predetermined threshold percentage.

14. A method as claimed in claim 1, wherein the step is included of determining a number of different grey levels within adjacent rows or columns comprising the pixels in the blocks along the circumference of the seed region and identifying a location of two adjacent pixel rows or columns exhibiting a largest difference in the number of different grey levels.

15. An apparatus for discriminating between natural and synthetic regions of an image composed of a matrix of rows and columns of pixels, the apparatus including a block selection unit for dividing luminance values of the pixels of the image into blocks; luminance gradient estimation means arranged for identifying whether the blocks are of a natural image type or a synthetic image type; and clustering means for further clustering blocks of a same type, characterized in that the luminance gradient estimation means is arranged to determine luminance gradient values by determining a first order difference value of the luminance values of the pixels in a row and a column direction of the block.

16. A display device comprising a display screen; and an image enhancer unit, characterized by comprising the apparatus as claimed in claim 15.
